(19) United States
(12) Patent Application Publication
(10) Pub. No.: US 2012/0299810 A1
(43) Pub. Date: Nov. 29, 2012

(54) Fingertip Input Device

(75) Inventor: CLAIRE ELIZABETH ANNE TRENT, IRVINE, CA (US)

(73) Assignee: CLAIRE ELIZABETH ANNE TRENT, IRVINE, CA (US)

(21) Appl. No.: 13/114,247

(22) Filed: May 24, 2011

(51) Int. Cl. G09G 5/00

(52) U.S. Cl. 345/156

(57) ABSTRACT

A Fingertip Input Device that is composed of a bead and a ring or thimble is worn around a fingertip. It is used to interact with a touch screen device and mimic the bare fingertip's actions.

The bead may be composed of any suitable material that is thermally and electrically conductive and can interact with the touch screen device. The ring or thimble may be composed of elastomer or any other suitable material to cover the fingertip.

### CROSS REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE OR A COMPUTER PROGRAM

N/A

### BACKGROUND OF THE INVENTION

This is regarding a Fingertip Input Device that may be used with an electronic device with touch screen technology.

Touch screen technology is used in many electronic devices that include, but are not limited to, cellular telephones, computer monitors, personal media players, handheld survey machines and restaurant order machines. Due to bacteria and oil present on the human skin, these touch screens may become contaminated, oily, or dirty. This could pose health risks to users or cause distorted screens.

Because these touch screens require interaction similar to finger use, but the finger use could contaminate the surface with health hazards or make it difficult to read the screen due to smudging, there is a need for a product that could reduce these negative outcomes.

### PRIOR ART

Glove-related implementations have been developed to improve the ability of users to keep warm in the winter and be able to use touch screen devices while continuing to wear gloves covering their fingertips. (Sunder, U.S. Pat. No. 7,874,021, Jan. 25, 2011, and Ning, U.S. Pat. No. 7,884,797, Feb. 8, 2011)

However, prior art has not addressed the need of users to regularly cover their fingertips with an interactive fingertip covering that may provide more sanitary conditions for the touch screen and user, may decrease smudging caused in all weather by hand oil and dirt, and may make user tactile entry more accurate, without the discomfort of the year-round glove.

### ADVANTAGES

Thus, several advantages of one or more aspects are that the Fingertip Input Device covers user-selected fingertips necessary to operate a touch screen device, that it may maintain more hygienic conditions for the user and touch screen, that it may prevent smudging from hand residue, and that it may increase input accuracy of commands. In addition, the embodiment may be worn as jewelry when not used to interact with the touch screen device. These and other advantages will become apparent from a consideration of the ensuing description and accompanying drawings.

### SUMMARY OF THE INVENTION

This embodiment is directed to the Fingertip Input Device that may include the elastomer band and the affixed thermally and electrically conductive bead that covers the finger and mimics the function of the fingertip to transmit user actions to the touch screen technology of the electronic device.

The bead may be manufactured from any suitable material that provides sufficient thermal and electrical conductivity to perform commands on the touch screen and covers at least a portion of the fingertip, in any shape (including but not limited to oval, flower, heart, square, rectangular, decorative, cylindrical, tube). The ring band may be made of any suitable material (including but not limited to metal, elastomer, or fabric) and may also be made in the shape of a thimble.

The application of the embodiment is to attach the ring or thimble to the first section of the finger or thumb nearest to the fingertip with the bead facing towards the electronic device's touch screen. Using normal motions to control the electronic device with the touch screen, the user will guide the bead and touch the screen to interact with the device. The embodiment is used in place of the bare fingertip to interact with the touch screen interface.

### BRIEF DESCRIPTION OF THE DRAWINGS

FIG. 1 is a cross-sectional view of the embodiment showing the ring band and attached bead.

FIG. 2 is a schematic view of the ring band and attached bead.

FIG. 3 is a schematic view of the embodiment positioned on the hand.

FIG. 4 is a schematic view of the embodiment in use on the touch screen.

FIG. 5 is a flow chart of an illustrative process by which the user may interact with the touch screen of the electronic device.

### DETAILED DESCRIPTION OF THE DRAWINGS

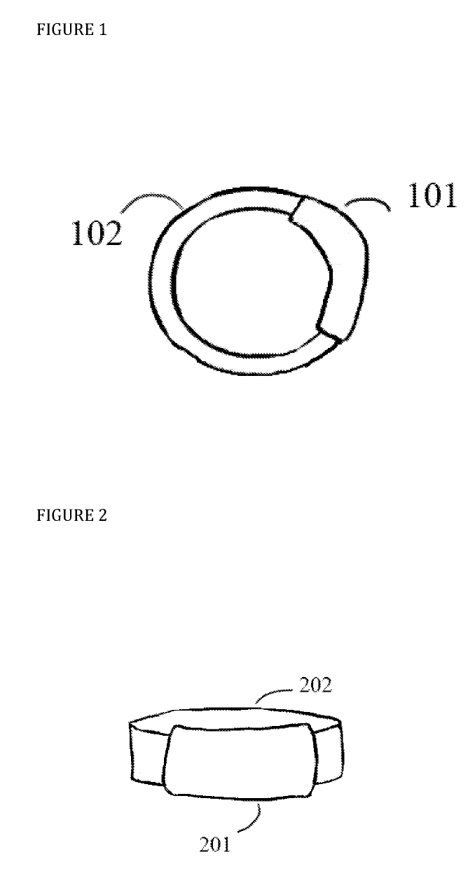

FIG. 1 is a cross-sectional view of the embodiment showing the ring band (102) and attached bead (101). The embodiment is composed of the complete ring band (102) with a portion of the band covered by the thermally and electrically conductive material (101) that may be metal. The ring band (102) is composed of elastomer or any suitable material. The bead (101) is composed of any thermally and electrically conductive metal that is suitable for the interactive application of use on the touch screen electronic device.

FIG. 2 is a schematic view of the ring band and attached bead. The embodiment is composed of the complete ring band (202) with a portion of the band covered by thermally and electrically conductive metal (201) or other suitable material. The ring band (202) is composed of elastomer or any suitable material.

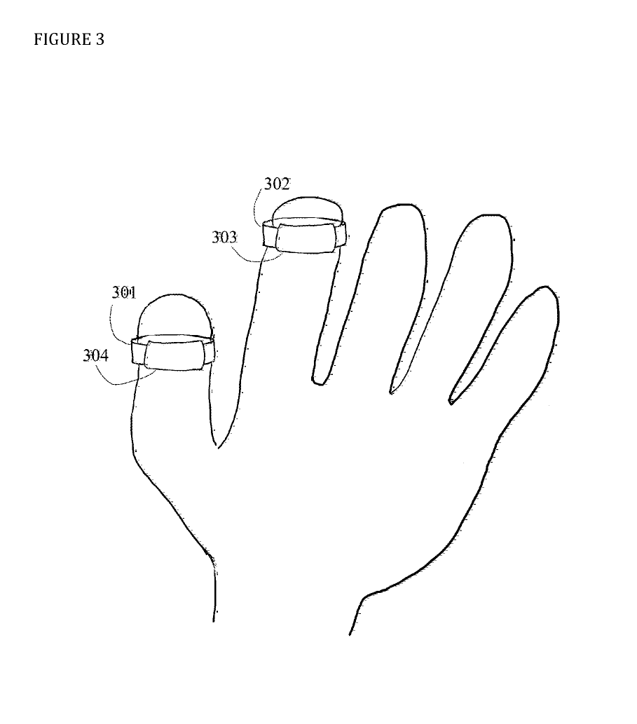

FIG. 3 is a schematic view of the embodiment positioned on the hand. The intention is for the thumb (301) or index finger (302) to be used and to position the ring band in the upper part of the finger towards the fingertip. The embodiment may be used on any finger, provided the user is comfortable manipulating the bead over the touch screen. This embodiment may also be worn ornamentally as jewelry when not in use on the touch screen. The bead (303, 304) on the ring band is positioned facing the palm of the hand for interaction with the touch screen.

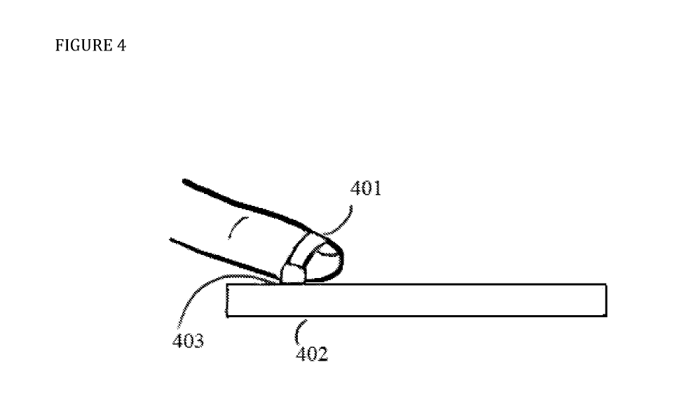

FIG. 4 is a schematic view of the embodiment in use on the touch screen. The embodiment (401) is attached to the fingertip area of the thumb or finger with the bead (403) facing towards the touch screen (402) of the electronic device. Using the bead (403), the user touches the screen (402) and moves the finger with the bead in the appropriate direction on the screen to perform the electronic device's functions. The embodiment is attached by pushing the finger through the circular opening in the ring and resting it in a comfortable position to interact with the electronic device.

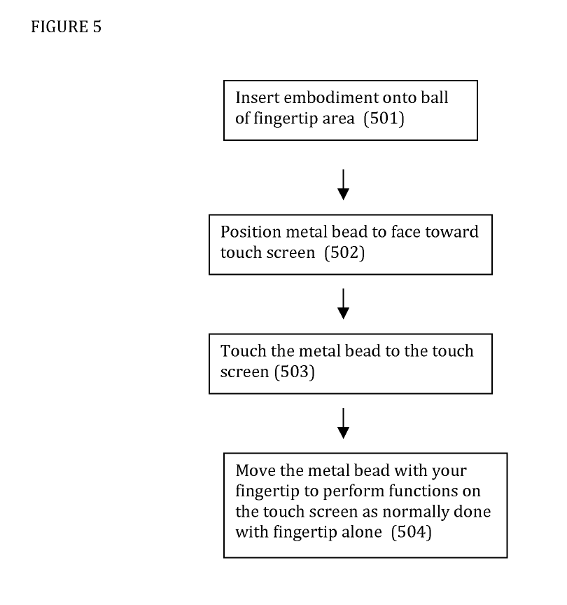

FIG. 5 is a flow chart of an illustrative process by which the user may interact with and command the touch screen of the electronic device. First, (501) the user places the embodiment onto the fingertip of the thumb or finger. Then, (502) the user ensures that the bead is facing towards the touch screen to prepare for interaction with the electronic device. Next, (503) the user touches the screen with the bead that is attached to the finger. Finally, (504) the user performs touch screen tasks using the bead in place of the fingertip, which would normally be touching the screen.

### DETAILED DESCRIPTION OF THE INVENTION

The embodiment of the Fingertip Input Device allows the user to contact the screen with the embodiment instead of using the bare fingertip. This may decrease screen smudging and bacterial contamination on the touch screen device (including but not limited to iPod, iPad, iTouch, cellular telephones).

The first embodiment is composed of the elastomer ring band and the metal bead that conducts heat and electricity (including but not limited to stainless steel, aluminum and silver). Wearing the ring on the ball of the fingertip, the user touches the screen with the metal bead and uses the same motions as with the bare fingertip to interact with the device.

The metal bead in the first embodiment is cylindrical around the ring, causing the user to touch the back of the bead fully with his finger to improve thermal and electrical conductivity.

The ring band for the first embodiment is composed of elastomer, which stretches to meet user size requirements, and can be easily repositioned to function as jewelry when the user is not interfacing with the electronic device.

The second embodiment may be elastomer or other suitable material formed into the ring band or thimble with the suitable thermally and electrically conductive substance attached in the form of the bead. The bead may take any form (including but not limited to a star, tube, cylinder, rectangle, square, circle, oval, flower, heart, or other shape). It may be rounded or flat.

What is claimed:

1. A fingertip input device for use on a touch screen to command an electronic device, comprising a ring, band or thimble composed of a suitable material that fits onto a fingertip of either a finger or thumb, with a bead attached to the fingertip, wherein the bead is thermally and electrically conductive and can interact with the touch screen to input commands in place of the bare finger tip.
